(19) United States
(12) Patent Application Publication
(10) Pub. No.: US 2018/0162632 A1
(43) Pub. Date: Jun. 14, 2018

(54) FLASHLIGHT COVER ASSEMBLY

(71) Applicant: VINCENT CRAIG, SAN DIEGO, CA (US)

(72) Inventor: VINCENT CRAIG, SAN DIEGO, CA (US)

(21) Appl. No.: 15/378,061

(22) Filed: Dec. 14, 2016

(51) Int. Cl. B65D 85/42; F21V 31/00; B65D 25/54

(52) U.S. Cl. CPC B65D 85/42; F21W 2131/402; B65D 25/54; F21V 31/00

(57) ABSTRACT

The present invention relates to a cover assembly for the flashlight which is similar to a slipcase that enables it to provide a protective cover to the flashlight at the time of its use for any work. The cover assembly herein is made up a body section which further comprises a coupling mean wherein; the coupling means have a self-adjustment property according to any shape and size of the flashlight. The cover assembly herein acts as a protective cover for the flashlight.

### FIELD OF THE INVENTION

The present invention relates to a cover assembly for the flashlight wherein, the cover assembly for the flashlight enables providing complete coverage of the flashlight and further enables protecting the flashlight from overspray, fouling, and contamination.

### BACKGROUND OF THE INVENTION

A flashlight (often called a torch) is a portable hand-held electric light. Usually, the source of the light is an incandescent light bulb or light-emitting diode (LED). A typical flashlight consists of a light bulb mounted in a reflector, a transparent cover (sometimes combined with a lens) to protect the light source and reflector, battery, and a switch.

However, at many workplaces a flashlight is used to aid visibility while working. In the process of painting overspray occurs, which is when very small particles of paint become airborne. This overspray can settle on all nearby surfaces, including the flashlight. Over time, the paint builds up and becomes completely opaque, rendering the flashlight useless. The labor involved in removing the paint may not be worth the value of the flashlight, so a flashlight that would otherwise work as intended is discarded.

Other situations that may foul a flashlight would be working in dirty or dangerous circumstances, such as a plumber, line inspector, mechanic or otherwise. Where the at least one user is working in unsanitary conditions or around substances that are difficult to remove and impair the function of the flashlight or may contaminate other nearby items or persons.

Therefore, there remains a need to overcome the problems mentioned above, and our invention resolve this entire problem.

### SUMMARY OF THE INVENTION

In order to overcome the problems of the prior art, the present invention of the cover assembly for the flashlight enables providing a cover for the complete coverage of the flashlight. Furthermore, it enables protecting the flashlight from overspray, fouling, and contamination.

The present invention of the cover assembly for the flashlight is similar to a slipcase provided for the flashlight. It is to provide a protective shield for the flashlight at the time of its use for any job. The cover assembly herein is made up of a body section which further comprises a coupling means wherein; the coupling means has a self-adjustment property according to any size flashlight. The body section herein has a front opening which enables it to receive the flashlight into the body section. The opening is made up of a flexible material to adjust according to any morphology of the flashlight. The head unit comprises a transparent lens coupled to it wherein, the transparent lens enables the light of the flashlight to pass through the head unit without any distortion.

### BRIEF DESCRIPTION OF THE DRAWING

The following drawings illustrate exemplary embodiment; however, they are helpful in illustrating the objects, features, and advantages of the present invention. The present invention will be more apparent from the following detailed description taken in conjunction with accompanying drawings in which;

FIG. 1 illustrates the exploded view 1 of the given invention according to an embodiment of the invention.

FIG. 2 illustrates the exploded view 2 of the given invention according to an embodiment of the invention.

### BRIEF DESCRIPTION OF THE INVENTION

Reference will now be made in detail to the exemplary embodiment (s) of the invention, examples of which are illustrated in the accompanying drawings. Whenever possible, the same reference numerals will be used throughout the drawings to refer to the same or like parts.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but not every embodiment or example necessarily includes that particular feature, structure, characteristic, property, element, or limitation. Further, repeated use of the phrase “in an embodiment” does not necessarily refer to the same embodiment.

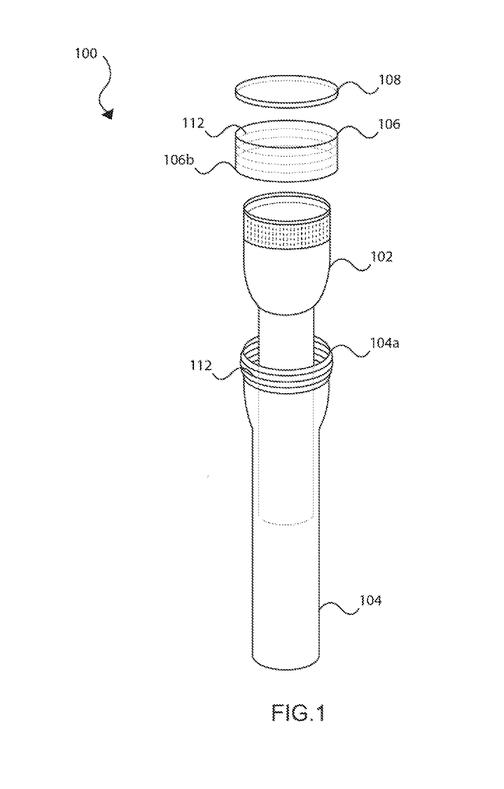

FIG. 1 illustrates the exploded view 1 of the given invention of a cover assembly [100] for flashlight [102] which comprises: a body section [104] and a head unit [106], wherein a first end [104a] of the body section [104] is removable-ly coupled to a second end [106a] of the head unit [106] which further enables to provide complete coverage of the flashlight [102] from any external harm. Herein, the head unit [106] has a transparent lens [108] enabling the light of the flashlight [102] to pass through the head unit [106]. The transparent lens [108] herein, is integrally or removable-ly coupled to the head unit [106]. The cover assembly [100] herein is in the form of a slipcase.

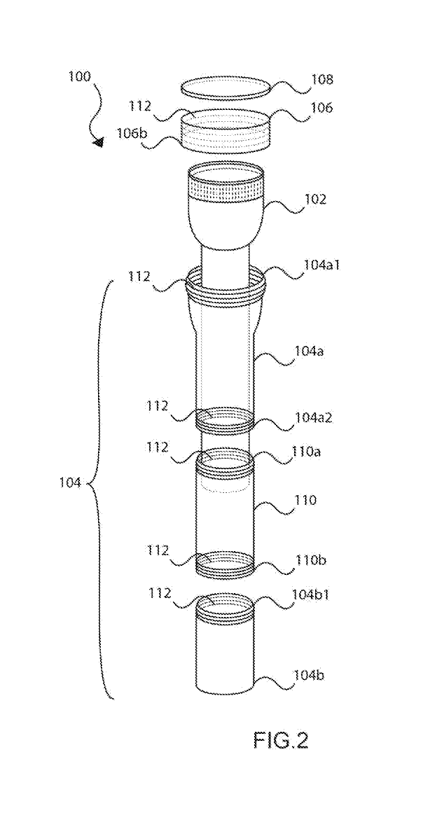

FIG. 2 illustrates the exploded view 2 of the given invention of a cover assembly [100] for flashlight [102] which comprises: a body section [104] and a head unit [106]. Herein, the body section [104] has an upper portion [104a] and a lower portion [104b] which are enabled to be coupled by at least one coupling means [110], wherein the coupling means [110] enables the adjustment of the length of the body section [104] according to a length of the flashlight [102]. Also, the head unit [106] has a transparent lens [108] which enables the light of the flashlight [102] to pass through the head unit [106]. The transparent lens [108] herein, is integrally or removable-ly coupled to the head unit [106]. Herein, the at least one coupling mean [110] couples to the upper portion [104a] and the lower portion [104b] of the body section by at least one of clips, rings or combination thereof. The first end [10a] of the coupling mean [110] couples to the second end [104a2] of the upper portion, [104a] and the second end [110b] of the coupling mean [110] couples to the first end [104b1] of the lower portion; [104b] of the body section [104] by means of rings [112]. The at least one coupling mean [110] enable the user to adjust the length of the cover assembly [100] according to the length of the flashlight [102]. Also, the body section [104] has a front opening [114] which is enabled to receive the flashlight [102] into the body section, [104] by enabling the coupling of the head unit [106] to the body section [104] with the rings [112], wherein the second end [106a] of the head unit [106] couples to the first end [104a1] of the upper portion [104a] of the body section [104] to cover the flashlight [102] by the cover assembly [100].

In a preferred embodiment; the at least one user first removes the head unit [106] of the cover assembly [100] which is removable-ly coupled to its body section, [104] in order to insert the flashlight [102] through the opening [114] into the body section [104]. Herein, the body section [104] couples to the head portion [106] by means of rings [112]. Once the flashlight [102] has been placed inside the body section [104] the second end [106a] of the head unit [106] is coupled to the first end [104a] of the body section [104] and further is enabled to form a slipcase. Also, the head unit [106] has a lens [108] which is either integrally or removable-ly coupled to the head unit [106] and enables the easy passage of the light through it.

In another embodiment, the at least one user is enabled to adjust the length of the cover assembly [100], in order to accommodate the flashlight [102] of different size. Herein, the user is provided with a cover assembly having a head unit [106] and body section [104], wherein the body section [104] further has an upper portion [104a], a lower portion [104b] and at least one coupling means [110]. The user who has a flashlight [102] of different length is then enabled to couple the first end; [110a] of the at least one coupling means [110] to the second end [104a2] of the upper portion [104a], and couple to the second end [110b] of the at least one coupling mean [110] to the first end [104b1] of the lower portion [104b]. This attachment of the at least one coupling mean [110] with the body portion [104] enables the adjustment of the length of the cover assembly [100] for accommodating the flashlight [102] of any size. The user is then enabled to insert the flashlight [102] through the opening [114] of the body section [104] and cover the opening [114] with the head unit [106], wherein the body section [104] couples to the head unit [106] by the means of rings [112]. Also, the head unit [106] has a lens [108] which is either integrally or removable-ly coupled to the head unit [106] and enables the easy passage of the light through it.

The cover assembly [100] herein is made up of at least two flexible transparent or translucent materials such as plastic, silicon, vellum, latex, acrylic, cellulose or the combination thereof for enabling the at least one user to see and actuate the various buttons provided on the body of the flashlight [102] through the cover assembly [100]. It is attached to a hard plastic, metal or the combination thereof rings [112] which are threaded to receive a head unit [106]. The cover assembly [100] for the flashlight [102] as a whole is designed to provide complete coverage of the flashlight [102] to protect it from overspray, fouling, and contamination. It is easily removable and is enabled to be disposed by the at least one user's discretion, in order to protect the function of the flashlight [102] at the time of its use.

While the invention has been described in detail with specific reference to preferred embodiments thereof, it is understood that variations and modifications thereof may be made without departing from the true spirit and scope of the invention.

What is claimed is:

1. A cover assembly for a flashlight comprises a body section and a head unit, wherein a first end of the body section is removable-ly coupled to a second end of the head unit which further enables it to provide complete coverage of the flashlight from any external harm.

2. The cover assembly of claim 1, wherein the cover assembly is made up of a transparent or translucent material such as plastic, silicon, vellum, latex, acrylic, cellulose or the combination thereof.

3. The cover assembly of claim 1, wherein the cover assembly is flexible in nature enabling at least one user to actuate the flashlight from outside the cover assembly.

4. The cover assembly of claim 1, wherein the head unit comprises a transparent lens enabling a light of the flashlight to pass through the head unit.

5. The cover assembly of claim 1, wherein the cover assembly is made up from a radio-opaque material.

6. The cover assembly of claim 1, wherein the body section further comprises at least one coupling mean to adjust a length of the body section according to a length of the flashlight.

7. A cover assembly for a flashlight comprises a body section and a head unit wherein; the body section further comprises an upper portion, a lower portion, and at least one coupling mean. Wherein a first end of the at least one coupling mean couples to a second end of the upper portion and a second end of the at least one coupling mean couples to a first end of the lower portion, to adjust the length of the body section according to the length of the flashlight.

8. The cover assembly of claim 7, wherein the cover assembly is made up of a transparent or translucent material such as plastic, silicon, vellum, latex, acrylic, cellulose or the combination thereof.

9. The cover assembly in claim 7, wherein the cover assembly is flexible in nature enabling at least one user to actuate the flashlight from outside the cover assembly.

10. The cover assembly of claim 7, wherein the head unit comprises a transparent lens enabling a light of the flashlight to pass through the head unit.

11. The cover assembly of claim 7, wherein the cover assembly is made up from a radio-opaque material.

12. The cover assembly of claim 7; wherein the coupling mean couples to the upper portion and lower portion of the body section by at least one of dips, rings or combination thereof.
